(19) United States
(12) Patent Application Publication
(10) Pub. No.: US 2017/0081522 A1
(43) Pub. Date: Mar. 23, 2017

(54) ANTI-FRICTION LACQUER AND SLIDING BEARING LAMINATE COMPRISING SAME

(71) Applicant: FEDERAL-MOGUL WIESBADEN GMBH, Wiesbaden (DE)

(72) Inventors: Achim ADAM, NAUHEIM (DE); Joachim SCHLUTER, WIESBADEN (DE)

(21) Appl. No.: 15/106,917

(22) PCT Filed: Dec. 22, 2014
(86) PCT No.: PCT/EP2014/079009

§ 371 Date: Nov. 28, 2016

(30) Foreign Application Priority Data
Dec. 27, 2013 (DE) 10 2013 227 186.7

(51) Int. Cl. C09D 5/00; C10M 125/22; C09D 179/08; F16C 33/10; C09D 171/00; F16C 33/20; F16C 9/02; F16C 9/04; C10M 157/02; C09D 7/12

(52) U.S. Cl. CPC C09D 5/00; C10M 157/02; C10M 125/22; C09D 179/08; C09D 7/1216; C09D 7/1275; C09D 171/00; C09D 7/125; F16C 33/201; F16C 9/02; F16C 9/04; F16C 33/1095; C10M 2213/0623; C10M 2217/044; C10M 2201/065; C10M 2201/003; C10M 2201/041; C10N 2240/02; C10M 2201/084; C10M 2229/02; C10M 2201/062; C10M 2209/103; C08K 3/30

(57) ABSTRACT

The invention relates to an anti-friction coating (11, 12, 41, 42, 43) and an anti-friction coating composite (10) comprising at least 25 vol. % of a binder (16) and comprising fillers, which include zinc sulfide (18) and barium sulfate (20) and optionally additional fillers, wherein the volume ratio of barium sulfate (20) to zinc sulfide (18) is between 0.1 and 15.7, preferably between 0.8 and 4.88, and particularly preferably between 1.5 and 3.44. The anti-friction coating composite (10,40) comprises at least two anti-friction coatings (11, 13) of different compositions. The invention further relates to sliding bearing layered composite materials comprising such coatings and use thereof in internal combustion engines.

The invention relates to an anti-friction coating comprising a binder and fillers favoring the sliding behavior. The invention relates further to the sliding bearing layered composite materials comprising such an anti-friction coating and furthermore the use of such a sliding bearing layered composite material in a bearing element for an internal combustion element, in particular in a bearing liner of a crankshaft bearing or of a connecting rod bearing, in a connecting rod bushing or on a thrust washer.

Sliding elements in internal combustion engines consist mostly of multilayer materials with specially modified surfaces, which optimize the sliding properties thereof. As a rule, the surfaces of sliding bearings are metallic layers, for example based on lead, tin or aluminum that are applied by galvanic processes, vapor deposition, or by mechanical plating. Non-metallic sliding layers are also known, which are based on synthetic resin and which are adaptable with respect to their sliding properties, load capacity, and wear resistance within certain limits to the requirements of the bearing position.

In particular, anti-friction coatings based on synthetic resin have been used for many years as agents for reducing the friction of mechanical components. As a rule, metal, plastic, and rubber parts are coated, which must be easily movable long-term without further lubrication. In typical applications the loads are relatively low and the boundary conditions such as temperature and media contact are not critical. It is also known from various patent applications, such as EP 0 984 182 A1, that lubricant lacquer may also be used in internal combustion engines, e.g. for a crankshaft bearing.

However, a disadvantage of the known anti-friction coatings is basically a relatively high, but sharply defined load capacity, which when exceeded causes a rapid destruction of the coating. The underlying substrate is then exposed. When the substrate material does not have sufficient emergency running properties, this results in a total failure of the bearing due to galling.

Copper or aluminum alloys are typically found as substrates with such bearings. The binder, also referred to as matrix material, usually consists of PAI, PI, epoxy resin, phenolic resin or PBI, see EP 1 775 487 A2. In EP 0 984 182 A1, in addition PEI, PEEK, aromatic polyamides, PTFE, and other fluoropolymers such as PFA, ETFE, and FEP are named as plastics for the coating with sliding material, in which context, however, no lubricant lacquers, but mostly thicker plastic coatings that are applied in paste-like manner are addressed, which are introduced under pressure into an open-pore structure of the substrate, for example into the pores of a metallic sinter structure and in this way anchor the sliding layer into the substrate. Such a coating is described, for example in EP 1 390 629 B1. It does not fall under the present generic group of anti-friction coatings. Most prominent representatives of such plastic layers are those based on PTFE. These are also not sufficiently capable of carrying a load, so they are ruled out for highly loaded bearings.

Lubricant lacquers are characterized by the fact that during application they are present in a low viscosity state, e.g. in solution or dispersion, or passthrough such a state, e.g. by melt-fusion, so that a smooth running, closed surface is formed without the influence of pressure. The application of the anti-friction coating takes place by spray or printing processes and subsequent thermal hardening or curing under UV-light. The binder of a lubricant coating is converted during the subsequent drying or hardening process by chemical or physical crosslinking processes or chemical transformation into a form harder to dissolve or harder to melt, so that the lubricant layer forms a dimensionally stable and highly loadable thin layer on a substrate. The self-forming smooth surface, which is to say being formed without action of pressure, enables the application of a uniformly thick anti-friction coating on sliding elements that are already shaped, for example bearing shells, which is not possible in the case of coatings applied in paste-like form, because with those a coating can only take place economically on a band-shaped semi-finished material, in other words, before the last mechanical shaping of the sliding element.

Typical functional fillers are solid lubricants such as MoS₂, WS₂, BN, PTFE, ceramic powders such as oxides, nitrides, carbides, silicates, metals such as, i.e., Al, Cu, Ag, W, Ni, Au, and Fe₂O, see WO2010/076306 or U.S. Pat. No. 6,305,847 B1.

As other fillers, BaSO₄ or ZnS are already known in tribologically stressed layers. A composition is known from DE 10 2006 048 311 A1 consisting of a plastic matrix with at most 20% PTFE and additives of 5% to 15% barium sulfate or zinc sulfide. EP 1 716 342 B1 presents, for example, a material having increased pore volume and a plastic matrix made of 50 vol. % PVDF or 60 vol. % PA, PS, or PPS, in which more than 5 vol. % PTFE and at least 5 vol. %, preferably 8 to 12 vol. % zinc sulfide or barium sulfate are contained. EP 1 526 296 A2 describes a material based on PEEK, PPS, or PA comprising a hard particle component and carbon fibers, without PTFE, having a ZnS or BaSO₄ content of 5 to 15 wt. %, wherein concretely only compositions containing ZnS are specified. In the document EP 1 716 342 B1, a sliding bearing composite material comprising a polymer-based lubricant layer is specified, which contains zinc sulfide and/or barium sulfate in a proportion of at least 5 vol. % and preferably 8-12 vol. %, wherein concretely only compositions are specified that contain either ZnS or BaSO₄. The filler combination of zinc sulfide and barium sulfate is also known, optionally with additional fillers. DE 36 01 569 A1 discloses the addition of fine particle ZnS and BaSO₄ as an additive for polymers in plastic composite sliding bearings, wherein in a zinc sulfide content of 5 to 40 vol. %, based on the matrix material, up to 5 vol. % BaSO₄, based on the zinc sulfide particles, may be contained. The embodiments are selected, so that either only zinc sulfide or only barium sulfate or zinc sulfide with minor quantities of 0.5 vol. % barium sulfate can be used. Apart from that, the mentioned disclosures all refer to self-lubricating layers based on PTFE, thus in turn to materials applied in paste-like form, which do not come into question for the relevant applications for the reasons stated and also do not belong to the class of anti-friction coatings.

The object of the invention is to achieve a further improvement of the wear resistance and load capacity of anti-friction coatings based on synthetic resin.

The object is achieved by an anti-friction coating comprising at least 25 vol. % of a binder and having fillers, which include zinc sulfide and barium sulfate and optionally further fillers, wherein the volume ratio of zinc sulfide to barium sulfate is between 0.1 and 15.7, preferably between 0.8 and 4.88 and particularly preferably between 1.5 and 3.44.

It has been shown that by means of the filler combination in the stated range amounts, the properties of anti-friction coatings are significantly improved compared to those containing either only zinc sulfide or only barium sulfate or both fillers in another ratio. These properties include in particular the load capacity and the wear resistance of the anti-friction coating. For example, the peak load capacity at the crankshaft bearings could be increased up to 120 MPa. This is a value which otherwise is achieved only by aluminum-based sputter coatings.

The peak load capacity can be decreased compared to anti-friction coatings with only one of the two components ZnS or BaSO₄ over the entire claimed range of the volume ratio of zinc sulfide to barium sulfate. In the narrower range up to a ratio of 1.5 to 3.44, the load capacity improves about up to 12 MPa and in the narrowest range between 1.5 and 3.44, the load capacity improves about up to 25 MPa.

It is believed that the effectiveness of the lubricant film is improved by the BaSO₄/ZnS mixture, whereby the increase of the wear rate with the specific bearing load is reduced. This increases the load limit, which in turn significantly increases the operational reliability of the bearing at load beneath the load limit.

Preferably, the anti-friction coating contains zinc sulfide and barium sulfate in total in a proportion of 2 to 35 vol. % and particularly preferably of 5 to 25 vol. %.

With smaller overall proportions, no significant improvement of the wear resistance and load capacity is detectable. Larger shares of both fillers lead to a weakening of the binding matrix.

Preferably, the total composition is optimized by the addition of further fillers. Fillers in this context are defined as all components other than the binder. The total filler content, thus the proportion of zinc sulfide, of barium sulfate and of the additional fillers is preferably at most 75 vol. %, particularly preferably not more than 60 vol. % of the total composition of the anti-friction coating.

It has also proved to be advantageous when the zinc sulfide and barium sulfate are present in powder form with a d50 value in the range of 0.1 μm to 1.0 μm. In this case, the primary grain sizes, thus the sizes of the individual grains, not those of agglomerates, of BaSO₄ and ZnS should be between 0.01 μm and 5 μm.

By this choice of the granulation of the powder, the wear rate can be effectively reduced. At the same time, the dispersibility of the filler in the anti-friction coating is very good, whereby a homogeneous anti-friction coating can be ensured in an easy manner.

Particularly preferably the zinc sulfide and barium sulfate content is present in the form of lithopone.

Lithopone is a mixture created by common precipitation of zinc sulfide and barium sulfate, which is obtainable with compositions of 10:90 to 60:40, which corresponds to a volume ratio of zinc sulfide to barium sulfate of 0.11 to 1.5.

Particularly preferably, the binder is selected from the group consisting of PAI, PI, epoxide resins, PBI, silicone resins, and highly aromatic thermoplastics, in particular polyarylates, PEEK, and PES.

All these substances are particularly suited due to their high temperature- and media-stability for use in the sliding bearings of an internal combustion engine.

The thickness of the anti-friction coating is preferably 1 μm to 40 μm. Here it should be noted that the coating thickness should be adjusted to the component size. It is true in particular that for radial bearings having a diameter up to 100 mm, a coating thickness of 5 to 25 μm is preferred. With large-size bearings above 100 mm diameter, a coating thickness up to 40 μm is preferred, in exceptional cases also up to 50 μm, because in the case of the large-size bearings an increased initial wear results due to geometric error and/or larger tolerances.

A particularly preferred embodiment of the anti-friction coating provides that the additional fillers comprise at least one solid lubricant.

The solid lubricant content should preferably be at least the same size as the ZnS/BaSO₄ proportion and particularly preferably be used in 1 to 5.7 times the amount of the ZnS/BaSO₄ mixture.

The addition of solid lubricants improves in particular the emergency running properties, i.e. the behavior under non-hydrodynamic operating conditions

Also preferred are solid lubricants selected from a group comprising metal sulfides having a layer structure, graphite, hexagonal boron nitride, and PTFE.

It is furthermore advantageous if the additional fillers contain at least one hard material at a total content of not more than 10 vol. %, based on the anti-friction coating. The one or more hard materials function as wear reduction agents in contact with the counter rotor, such as with a radial bearing, e.g. a shaft, for conditioning of the same. In particular, phase unevenness and/or excessive roughness of the shaft surface in a wearing-in phase are rapidly removed, until the shaft surface is adapted to the surface of the supporting sliding layer of the bearing. The hard material content should thus not exceed a volume fraction of 10%, since otherwise the material acts in a too strongly abrasive manner on the running surface of the counter rotor and the sliding properties of the bearing overall deteriorate.

The at least one hard material is preferably selected from a group comprising nitrides, carbides, borides, oxides, in particular SiC, Si₃N₄, B₄C₃, c-BN (cubic boron nitride), TiO₂, and SiO₂.

In a further advantageous embodiment, the additional fillers include at least one metal powder of total content not more than 30 vol. %, based on the anti-friction coating.

Such metal powders provide an increase of the thermal conductivity and thereby decrease the equilibrium temperature, which in particular significantly raises the permanent load capacity of thermally highly stressed sliding bearings in internal combustion engines. The volume fraction of the metal powder should, as far as is possible, not exceed 30%, since larger proportions are difficult to disperse in the anti-friction coating and therefore act negatively on the workability of the same.

The at least one metal powder is preferably selected from a group comprising the elements Ag, Pb, Au, Sn, Al, Bi, Cu, and alloys of these elements.

Most particularly preferred, the anti-friction coating contains as additional filler up to 15 vol. %, preferably 1 to 10 vol. % iron-(III)-oxide.

This filler in particular has proved to be helpful in reducing the wear rate in conjunction with the fillers zinc sulfide and barium sulfate in the proportions according to the invention.

The above-mentioned fillers may be present overall in a maximum amount of 75 vol. %, based on the total anti-friction coating and each within the stated range limits in the anti-friction coating. The remainder, thus at least 25 vol. %, consists of the said binder.

The object is further achieved by means of an anti-friction coating composite comprising at least two anti-friction coatings of different compositions within the parameter ranges state above.

In this way, a multilayer system can be produced from BaSO₄- and ZnS-containing lubricant lacquers, which is always optimally adjusted to changing operating conditions during operation. Concrete embodiments follow.

According to a further aspect, the invention provides a sliding bearing layered composite material comprising at least one metallic layer and an anti-friction coating applied on the surface of the metal layer or an anti-friction coating composite applied on the surface of the metal layer having the characteristics named above.

The at least one metal layer forms the substrate, and on the surface thereof according to an advantageous embodiment is situated an anti-friction coating composite comprising a lower anti-friction coating applied on the metal layer and an upper anti-friction coating applied on the lower anti-friction coating.

In an advantageous embodiment, an anti-friction coating composite comprising a lower anti-friction coating comprising solid lubricants and/or metal powder applied on the metal layer and an upper anti-friction coating containing hard materials applied on the lower anti-friction coating is disposed on the surface of the metal layer. The upper anti-friction coating, which is the first to come into contact with the counter rotor, is configured functionally as a wear-in layer, which serves to condition the counter rotor (the shaft) by the use of hard particles. The underlying anti-friction coating is designed as a lifetime layer and has within the above-mentioned ranges a higher fraction of metal powder and solid lubricants and substantially no or little hard materials and is therefore much more resistant to wear.

An alternative advantageous embodiment provides that on the surface of the metal layer an anti-friction coating composite is disposed comprising a lower anti-friction coating applied on the metal layer and an upper anti-friction coating applied on the lower anti-friction coating, the upper coating having a reduced proportion of binder compared to that in the lower anti-friction coating. The filler composition can thereby be the same in the simplest case, but also be different.

The anti-friction coating designed once again as the wear-in layer undergoes, due to the lower fraction of binder, an accelerated adaptation to geometric conditions, for example an inclination or deflection of the shaft, whereby local overloads, e.g. in the edge region of the bearing element, are reduced or avoided.

The sliding bearing coating composite material can also comprise an additional anti-friction coating under the lifetime layer, i.e. in direct contact with the surface of the metal layer, which thereby further raises the operational reliability of the bearing by being optimized in particular with respect to its wear resistance, e.g. in particular to delay a complete pass-through on the bearing material, after the lifetime layer is worn out. This is accomplished, for example due to an increased proportion of binder and/or an increased amount of wear-inhibiting hard particles.

In an alternative embodiment, an additional layer may be provided between the metal layer and the lower anti-friction coating, which is optimized relative to the adhesive bonding of the anti-friction coating composite on the metal layer. This has the effect of a primer coating and can usually be achieved already by a very thin layer provided with little or even no fillers, in particular one only a few μm thick.

The anti-friction coating composite can be realized in the form of discrete layers of anti-friction coatings of different compositions or as gradient layers, wherein the layer composition and thus the layer properties continually interchange.

The sliding bearing coating composite material of the invention is preferably further refined, in that the surface of the at least one metal layer, upon which the anti-friction coating is applied, has a roughness R_{z} of 1 μm to 10 μm, preferably of 3 μm to 8 μm.

A roughness in this range improves the adhesion of the anti-friction coating applied directly on the surface. Furthermore, such a roughness has the effect that with a gradual wear of the anti-friction coating the counter rotor at first only comes into contact selectively with individual peaks of the metal layer, which initially only account for a minor part of the surface of the exposed sliding surface, whereby the load capacity thereof increases. This counteracts a progressing wear before the total surface of the metal layer comes into contact with the counter rotor and the resulting vulnerability to galling of larger exposed areas leads to a total failure of the bearing.

The advantageous surface roughness can be produced by mechanical abrasion of the metal surface, for example by sand blasting or grinding, or by chemical removal, for example by phosphating or etching. Alternatively, to irregular roughnesses, regular substrate structures that may result from boring, reaming, or stamping are also to be understood as roughnesses in the sense of this embodiment.

The sliding bearing layered composite material is advantageously further structured such that the at least one metal layer has a bearing metal layer or a cover layer made from an alloy based on one of the elements selected from the group consisting of Cu, Al, Ni, Sn, Zn, Ag, Au, Bi, and Fe.

The metal layer may then be formed both as a comparatively thick support layer or as a thin top layer, wherein the anti-friction coating can be formed, depending on the composition, as an additional wear-in layer to adapt or condition the counter rotor or as a separate sliding layer with higher lifetime.

Particularly preferably the at least one metal layer is a bearing metal layer or top layer made of an alloy selected from the group consisting of CuSn, CuNiSi, CuZn, CuSnZn, AlSn, AlSi, AlSnSi, and AlZn. Some particularly preferred candidates are the alloys CuNi2Si, CuSn8Ni, CuSn10Bi3, CuPb23Sn, AlSn10Mn2NiCu, AlSn6Si4CuMnCr, and AlNi2MnCu.

Another advantageous embodiment of the sliding bearing layered composite material comprising a bearing metal layer and/or a top layer of the type described above is characterized in that the at least one metal layer also includes a steel support layer, thereupon the bearing metal layer and/or top layer and optionally an intermediate layer made of Ni, Ag, Cu, or Fe applied on the bearing metal layer, wherein the anti-friction coating or the anti-friction coating composite is applied on a surface of the bearing metal coating or top layer, or, if present, on the intermediate layer on the side facing away from the steel support layer.

Most particularly preferred, the top layer in such a sliding bearing layered composite material is one formed from a high load capacity AlSn-sputter layer, wherein the anti-friction coating or the anti-friction coating composite is designed functionally in particular as a wear-in layer, i.e. comprising at least one hard material of the type mentioned above and/or a binder content within the lower range according to the invention.

The object is achieved further by the use of a sliding bearing layered composite material of the type described above in a bearing element for an internal combustion engine, in particular for a bearing shell of a crankshaft bearing, for a bearing shell of a connecting rod bearing, for a connecting rod bushing, or for a thrust washer.

Functionally, these bearings are a matter of particularly highly loaded bearing elements in modern internal combustion engines in a thermally and chemically aggressive environment, in which to date anti-friction coatings were not considered to have adequate load capacity either as a wear-in layer or as a lubricant coating.

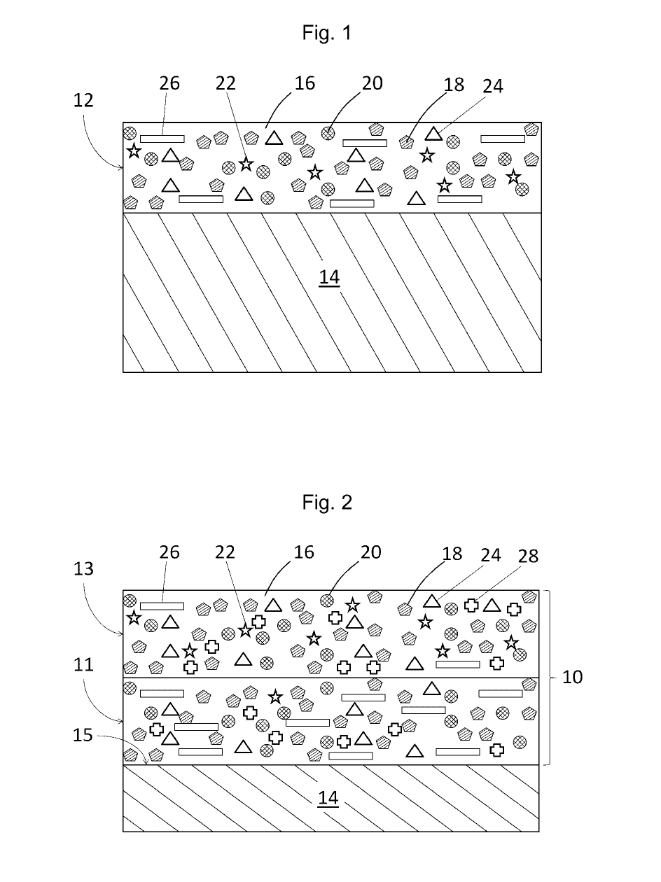

FIG. 1 a schematic diagram illustrating the inventive anti-friction coating on a substrate;

FIG. 2 a schematic diagram illustrating an embodiment of the inventive anti-friction coating composite on a substrate;

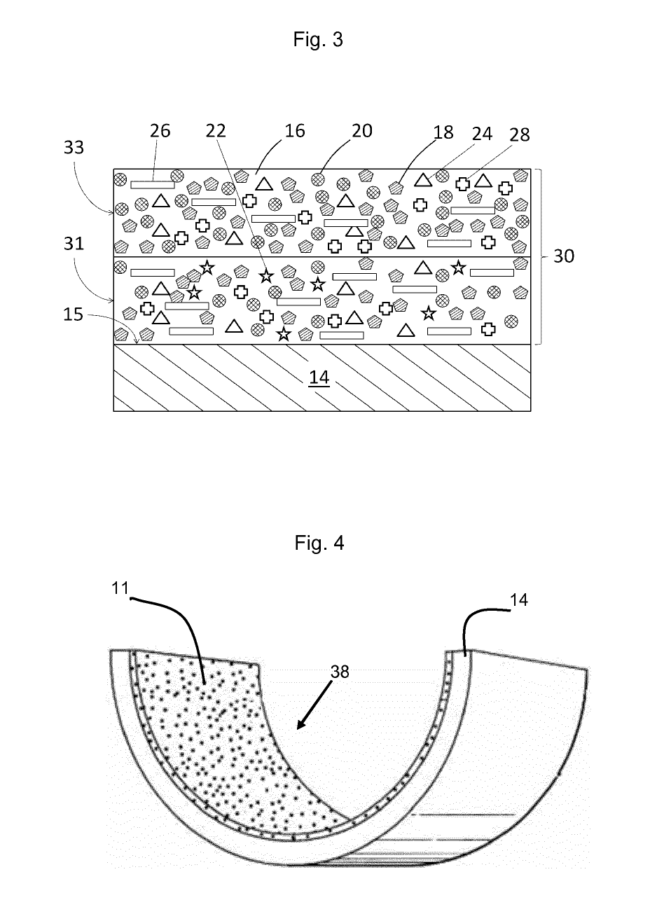

FIG. 3 a schematic diagram illustrating an alternative embodiment of the inventive anti-friction coating composite on a substrate;

FIG. 4 a perspective representation of an inventive bearing shell having an anti-friction coating; and

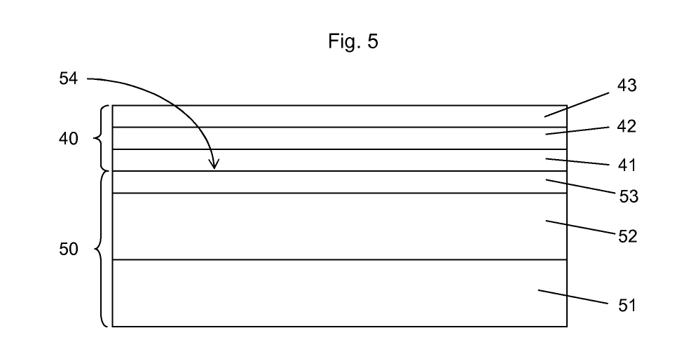

FIG. 5 a schematic diagram illustrating the layer construction of a sliding bearing layered composite material according to the invention.

In FIG. 1, a simple construction comprising an anti-friction coating 12 according to the invention on a not clearly specified substrate 14 is depicted schematically simplified. The geometrical relationships, in particular the layer thicknesses, are not closely drawn to scale for illustration purposes. The anti-friction coating 12 consists of a binder 16 as matrix component, in which a plurality of fillers is embedded. Fillers contained according to the invention are zinc sulfide 18 and barium sulfate 20. The anti-friction coating 12 shown further contains as optional fillers hard material particles 22, metal powder particles 24, and solid lubricant particles 26.

In FIG. 2, an exemplary construction of an anti-friction coating composite 10 consisting of a lower anti-friction coating 11 and an upper anti-friction coating 13 is shown. The lower anti-friction coating 11 is applied on a substrate 14 and more precisely on the surface 15 thereof and the upper anti-friction coating 13 is applied on the lower anti-friction coating 11. Both anti-friction coatings 11 and 13 comprise, in addition to a binder 16 as a matrix component the fillers zinc sulfide 18, barium sulfate 20, and Fe₂O₃ 28, according to the invention, but otherwise contain further different filler compositions. Both anti-friction coatings 11 and 13 in turn contain as examples the optional fillers hard material particles 22, metal powder particles 24 and solid lubricant particles 26, but with different emphases. While a higher proportion of solid lubricant particles 26 and hardly any hard material particles 22 are contained in the matrix of the lower anti-friction coating 11, the situation is exactly opposite in the case of the upper anti-friction coating 13. This composition is so chosen that the upper anti-friction coating 13, which comes into contact first with the counter rotor in the initial operation of the bearing, acts abrasively due to the hard materials and promotes a wear-in of the sliding partner. The lower anti-friction coating 11, however, first enters into contact with the counter rotor after the wearing-in process, i.e. after wear-out of the upper anti-friction coating 13 and acts to reduce friction due to the higher proportion of solid lubricant. Small hard material proportions are useful to slow down the wear of the layer.

However, in deviation from the illustration, the hard particles in the lower anti-friction coating 11 and/or the solid lubricant in the upper anti-friction coating 13 can be entirely dispensed with. The important point here is the increased fraction of hard materials in the upper anti-friction coating and the increased fraction of the solid lubricants and/or metal powder particles in the lower.

In FIG. 3, an alternative construction of an anti-friction coating composite 30 consisting of a lower anti-friction coating 31 and an upper anti-friction coating 33 is shown. The lower anti-friction coating 31 is applied on a substrate 14 and precisely on the surface 15 thereof and the upper anti-friction coating 33 is applied on the lower anti-friction coating 31. Both anti-friction coatings 31 and 33 comprise in addition to a binder resin 16 as matrix component the fillers zinc sulfide 18, barium sulfate 20, and Fe₂O₃ 28 according to the invention, but otherwise contain different further filler compositions. In both anti-friction coatings 31 and 33 the optional fillers, metal particles 24, and solid lubricant particles 26 are contained in turn by way of example. Additionally, hard material particles 22 are again also contained in the matrix of the lower anti-friction coating 31. On the contrary, the upper anti-friction coating 33 contains a smaller binder proportion and no hard material particles. This composition is selected so that the upper anti-friction coating 33, which comes into contact first with the counter rotor in the initial operation of the bearing, can adapt more rapidly to the counter rotor partner due to the lower proportion of binder. The lower anti-friction coating 31, on the contrary, first enters into contact with the counter rotor after the wear-in process, i.e. after the wear-out of the upper anti-friction coating 33 and has higher wear resistance and load capacity due to the higher binder content.

In deviation from the illustration, a hard material component may also be contained in the upper anti-friction coating 33. The important point here is the smaller proportion of binder.

FIG. 4 depicts a bearing shell 38 in perspective illustration, wherein a sliding bearing layered composite material is used. The layer structure of the sliding bearing layered composite material is then limited, in that the anti-friction coating 11 is applied on a non-differentiated depicted substrate 14. The substrate itself consists of at least one metal layer, whose function may be varied. First of all, it serves the mechanical stability of the bearing shell. For this purpose, it has either a fixed bearing metal solid material or a steel support layer with a bearing metal layer arranged thereon. The bearing metal layer undertakes in both cases the supporting function of the bearing. Due to emergency properties and embeddability for dirt particles, it can also be designed for direct contact with the sliding partners. Thereupon is then optionally a sliding or top layer made of metal. In this case the anti-friction coating 11 by itself takes on the function of a wear-in layer. Otherwise the anti-friction coating 11 may function as sliding layer by itself with choice of suitable fillers. Of course, instead of the single anti-friction coating 11 an anti-friction coating composite having different function can be provided, as explained above with reference to FIG. 2 and FIG. 3.

All lubricant lacquers are low-viscose, so that upon application, in particular by spray processes without action by pressure, they form a smooth running surface. After the subsequent drying or hardening processes (thermally or under UV-light) the binder of the lubricant coating is crosslinked or chemically or physically transformed, so that the sliding layer forms a dimensionally stable, to the greatest extent insoluble, and highly loadable thin layer on the substrate. The smooth layer formed by itself, i.e. without action of pressure, makes possible the application of an anti-friction coating also on already transformed sliding elements, such as the bearing shells shown in FIG. 3.

FIG. 5 shows a schematic diagram illustrating the layer structuring of a sliding bearing layered composite material according to the invention, in which once again several of the above-mentioned layer combinations are summarized by way of example.

The sliding bearing layered composite material comprises on the one hand an anti-friction coating composite 40 having several anti-friction coatings 41, 42, 43 and on the other hand a substrate 50 made of several metal layers 51, 52, 53. At the very bottom a steel support layer 51 is provided as stabilizing element. A bearing metal layer 52 is disposed on this. An intermediate layer 53 is disposed on the bearing metal layer 52 as adhesion promoter to the overlying anti-friction coating composite 40. This adhesion promoter can also be dispensed with, depending on the composition of the bearing metal, if the bearing metal layer forms an adequate adhesive base, for example, has a sufficient roughness. The anti-friction coating composite 40 is applied on the top side that is on the surface 54 of the intermediate layer 53 facing away from the steel support layer 51. This composite includes a first anti-friction coating 41, which is applied directly on the surface 54. The anti-friction coating 41 can be designed functionally different. Depending on the properties of the bearing metal or the intermediate layer, it can also serve as adhesion promoter for the overlying anti-friction coating. In this case, the coating can contain only a little or even no fillers at all and thus would not necessarily be counted among the anti-friction coatings according to the invention. Otherwise, it may serve to further increase the operational reliability, if a filler combination is chosen, which is optimized relative to the wear resistance thereof, so that a complete passage through the bearing material can be delayed, after the lower anti-friction coating 42 disposed thereover is worn out. This can take place e.g. by increasing the binder content and the proportion of the harder components, whereby the properties adaptability, galling resistance and friction fade into the background. It is thereby assumed that this layer is exposed only locally and slowly and thus the sliding properties of the total surface are not substantially impaired over a longer time period.

The lower anti-friction layer 42 according to the invention comprises zinc sulfide and barium sulfate and further solid lubricants and/or metal powder, if appropriate also hard material particles and/or iron-(III)-oxide in a composition, which forms the best compromise for bearing capacity and wear resistance on the one hand and adaptability, friction, and galling resistance on the other, and in this way a long-term stable layer is created under the given conditions of use. The upper anti-friction coating is then applied on the lower anti-friction coating 42, corresponding to the above in connection with FIG. 2.

Particularly preferred embodiments of particular anti-friction coatings have the following components:

Example a: PAI, BaSO₄, ZnS, h-BN, Fe₂O₃
Example b: PAI, BaSO₄, ZnS, MoS₂, Fe₂O₃
Example c: epoxy resin, BaSO₄, ZnS, MoS₂, Fe₂O₃
Example d: PEEK, BaSO₄, ZnS, PTFE, Fe₂O₃
Example e: silicone resin, BaSO₄, ZnS, graphite, Fe₂O₃

Underwood tests were carried out to evaluate the performance capacity of the anti-friction coatings or the sliding bearing layered composite materials. Thereby, a shaft rotates with eccentric weights in rigidly mounted connection rods. The mounting in the connecting rods is formed by the test bearings. The test bearings have a wall thickness of 1.4 mm and a diameter of 50 mm. The specific load is adjusted over the bearing width, the rotational speed is 4000 rpm. Evaluation criteria are sliding layer fatigue and wear after a 100 h continuous run. The load limit (UW load) is given in MPa, wherein the layer up to the substrate is worn down up to a maximum of 5% of the sliding surface or fatigue is present.

The following Table 1 reports the test results for sliding bearing layered composite materials comprising steel backs and a CuNi2Si bearing metal as substrate and various anti-friction coatings based on a PAI-binders and without an intermediate layer. Three comparative materials R1 to R3, which contained either only barium sulfate, only zinc sulfide, or none of the two fillers, are compared with examples according to the invention having different ratios of barium sulfate to zinc sulfide. The filler proportions were otherwise selected to be the same in each case, based on the anti-friction coatings.

TABLE 1

| | | | | | | Total | | |
|---|---|---|---|---|---|---|---|---|
| | | | | | | Content | | max |
| | | | | | Ratio | BaSO4 + | | UW |
| | | | BaSO4 | ZnS | BaSO4/ | ZnS | Solid | load |
| No. | Substrate | Binder | [vol. %] | [vol. %] | ZnS | [vol. %] | lubricant | [MPa] |
| R1 | CuNi2Si | PAI | 0 | 0 | | 0 | 40 vol % MoS2 | 90 |
| R2 | CuNi2Si | PAI | 15 | 0 | ∞ | 15 | 25 vol % MoS2 | 80 |
| R3 | CuNi2Si | PAI | 0 | 15 | 0 | 15 | 25 vol % MoS2 | 85 |
| 1 | CuNi2Si | PAI | 1.4 | 13.6 | 0.10 | 15 | 25 vol % MoS2 | 95 |
| 2 | CuNi2Si | PAI | 6.7 | 8.3 | 0.81 | 15 | 25 vol % MoS2 | 100 |
| 3 | CuNi2Si | PAI | 9 | 6 | 1.50 | 15 | 25 vol % MoS2 | 105 |
| 4 | CuNi2Si | PAI | 11 | 4 | 2.75 | 15 | 25 vol % MoS2 | 110 |
| 5 | CuNi2Si | PAI | 11.8 | 3.2 | 3.69 | 15 | 25 vol % MoS2 | 105 |
| 6 | CuNi2Si | PAI | 12.4 | 2.6 | 4.77 | 15 | 25 vol % MoS2 | 100 |
| 7 | CuNi2Si | PAI | 14.1 | 0.9 | 15.67 | 15 | 25 vol % MoS2 | 95 |

The ratios of BaSO₄ to ZnS in Table 1 are selected so that the effectiveness of the advantageous ranges according to the invention is clear. In the range of the ratio of 0.1 to 15.7 the load capacity is above those of ratios not in accordance with the invention, that is, at 95 MPa or more. Between 0.8 and 4.88, values result above 100 MPa; between 1.5 and 3.44, the highest values occur at a BaSO₄/ZnS-ratio of 2.75 with an optimum of 110 MPa.

The following Table 2 reports the test results for sliding bearing layered composite materials comprising steel backs and a CuSn8Ni-bearing metal as substrate and various anti-friction coatings based on PAI-binder and without an intermediate layer. Three reference examples not associated with the invention are compared with four examples according to the invention having approximately the same ratio of barium sulfate to zinc sulfide, but different total contents of barium sulfate and zinc sulfide and partly different further filler proportions of the solid lubricant MoS₂.

TABLE 2

| | | | | | | Total | | |
|---|---|---|---|---|---|---|---|---|
| | | | | | | Content | | max |
| | | | | | Ratio | BaSO4 + | | UW |
| | | | BaSO4 | ZnS | BaSO4/ | ZnS | Solid | load |
| No. | Substrate | Binder | [vol. %] | [vol. %] | ZnS | [vol. %] | lubricant | [MPa] |
| R4 | CuSn8Ni | PAI | 0.73 | 0.26 | 2.81 | 0.99 | 25 vol % MoS2 | 75 |
| R5 | CuSn8Ni | PAI | 44 | 16 | 2.75 | 60 | 0 | 25 |
| R6 | CuSn8Ni | PAI | 38.9 | 14.1 | 2.76 | 53 | 25 vol % MoS2 | 30 |
| 8 | CuSn8Ni | PAI | 38.9 | 14.1 | 2.76 | 53 | 20 vol % MoS2 | 45 |
| 9 | CuSn8Ni | PAI | 1.47 | 0.53 | 2.77 | 2 | 25 vol % MoS2 | 80 |
| 10 | CuSn8Ni | PAI | 4.4 | 1.6 | 2.75 | 6 | 25 vol % MoS2 | 85 |
| 11 | CuSn8Ni | PAI | 18.3 | 6.7 | 2.73 | 25 | 25 vol % MoS2 | 85 |

The total amounts of the BaSO₄—ZnS mixture are selected in Table 2, so that the effectiveness of the advantageous ranges according to the invention are clear. In the quantity range of 2 to 25 vol. %, the load capacities are above those not according to the invention or less advantageous according to the invention, as the comparison of examples 9, 10, 11 with the reference examples R4 and R5 shows. The comparison of R6 (78 vol. %) with example 8 (73 vol. %) proves the effect of an overdose of the content of all fillers together. The load capacity of example 8 at 45 MPa is certainly rather low, but this can be quite sufficient for a wear-in layer, e.g. in a multilayer system. Example 8 is moreover significantly better than example R6, which is not in accordance with the invention, wherein the total filler content exceeds the limiting value of 75%.

The following Table 3 reports the test results for sliding bearing layered composite materials comprising steel backs and a CuNi2Si-bearing metal as substrate and various anti-friction coatings based on a PAI-binders and without an intermediate layer. Four examples according to the invention are compared having substantially the same ratios and the same total content of barium sulfate and zinc sulfide, wherein these fillers are added in two cases, however, in the form of lithopone having a BaSO₄/ZnS volume ratio 2.13 (quantity detail marked “L”). Furthermore, the solid lubricant was varied in each case, but its respective proportion in the total composition remained the same. Additionally, Fe₂O₃ was used in three examples.

TABLE 3

| | | | | | | | | Total | | | |
|---|---|---|---|---|---|---|---|---|---|---|---|
| | | | | | | | | Content | | | max |
| | | | | | | | Ratio | BaSO4 + | | | UW |
| | | | BaSO4 | | ZnS | | BaSO4/ | ZnS | Solid | Amount | load |
| No. | Substrate | Binder | [vol. %] | | [vol. %] | | ZnS | [vol. %] | lubricant | Fe₂O₃ | [MPa] |
| 12 | CuNi2Si | PAI | 10.2 | L | 4.8 | L | 2.13 | 15 | 25 vol % MoS2 | | 110 |
| 13 | CuNi2Si | PAI | 11 | | 4 | | 2.75 | 15 | 20 vol % MoS2 | 5 | 115 |
| 14 | CuNi2Si | PAI | 10.2 | | 4.8 | | 2.13 | 15 | 20 vol % hBN | 5 | 115 |
| 15 | CuNi2Si | PAI | 10.2 | L | 4.8 | L | 2.13 | 15 | 20 vol % hBN | 5 | 120 |

Table 3 proves that further improvements are achievable by use of lithopone in place of a mixture of BaSO₄ and ZnS as well as the use of Fe₂O₃, optimally up to a load capacity of 120 MPa.

The following Table 4 reports the test results for sliding bearing layered composite materials comprising steel backs and a CuNi2Si-bearing metal as substrate and various anti-friction coatings based on different matrix materials without intermediate layer. Ten comparative materials are compared marked with prefix “R,” which contain neither barium sulfate nor zinc sulfide, and in each case a material assigned according to the invention having identical total filler content but different filler compositions. Also here, in one case the barium sulfate and the zinc sulfide were added in the form of lithopone (distinguishing mark “L”).

TABLE 4

| | | | | | | | | Total | | | | | |
|---|---|---|---|---|---|---|---|---|---|---|---|---|---|
| | | | | | | | | Content | | | | | max |
| | | | | | | | Ratio | BaSO4 + | | | | Amount | UW |
| | | | BaSO4 | | ZnS | | BaSO4/ | ZnS | Solid | Hard | | Fe₂O₃ | load |
| No. | Substrate | Binder | [vol. %] | | [vol. %] | | ZnS | [vol. %] | lubricant | material | Metal | [vol. %] | [MPa] |
| 16 | CuNi2Si | PAI | 7.3 | | 2.7 | | 2.65 | 10 | 20 vol % hBN | 5 vol % | | | 110 |
| | | | | | | | | | | SiC | | | |
| R16 | CuNi2Si | PAI | | | | | | 0 | 20 vol % hBN | 5 vol % | | | 85 |
| | | | | | | | | | | SiC | | | |
| 17 | CuNi2Si | PAI | 11 | | 4 | | 2.75 | 15 | 20 vol % MoS2 | | | | 105 |
| R17 | CuNi2Si | PAI | | | | | | 0 | 20 vol % MoS2 | | | | 85 |
| 18 | CuNi2Si | PAI | 5.9 | | 2.1 | | 2.81 | 8 | 15 vol % WS2 | | | | 110 |
| R18 | CuNi2Si | PAI | | | | | | 0 | 23 vol % WS2 | | | | 90 |
| 19 | CuNi2Si | PAI | 3.7 | | 1.3 | | 2.84 | 5 | 12 vol % Graphite | | | 3 | 95 |
| R19 | CuNi2Si | PAI | | | | | | 0 | 12 vol % Graphite | | | 3 | 90 |
| 20 | CuNi2Si | PAI | 10.2 | L | 4.8 | L | 2.13 | 15 | 20 vol % PTFE | | | | 95 |
| R20 | CuNi2Si | PAI | | | | | | 0 | 30 vol % PTFE | | | | 80 |
| 21 | CuNi2Si | PEEK | 10 | | 5 | | 2 | 15 | 20 vol % MoS2 | | | | 100 |
| R21 | CuNi2Si | PEEK | | | | | | 0 | 35 vol % MoS2 | | | | 85 |
| 22 | CuSn10Bi3 | PAI | 4 | | 1 | | 4 | 5 | 15 vol % MoS2 | 5 vol % | | 5 | 95 |
| R22 | CuSn10Bi3 | PAI | | | | | | 0 | 20 vol % MoS2 | 5 vol % | | 5 | 85 |
| 23 | CuSn10Bi3 | PES | 18 | | 7 | | 2.57 | 25 | 15 vol % MoS2 | | | | 105 |
| R23 | CuSn10Bi3 | PES | | | | | | 0 | 40 vol % MoS2 | | | | 95 |
| 24 | CuSn10Bi3 | EP | 11 | | 4 | | 2.75 | 15 | 20 vol % MoS2 | | | | 105 |
| R24 | CuSn10Bi3 | EP | | | | | | 0 | 20 vol % MoS2 | | | | 85 |
| 25 | CuSn10Bi3 | PAI | 3.7 | | 1.3 | | 2.84 | 5 | 15 vol % hBN | | 5 | 3 | 95 |
| | | | | | | | | | | | vol % | | |
| | | | | | | | | | | | Sn | | |
| R25 | CuSn10Bi3 | PAI | | | | | 2.84 | 0 | 20 vol % hBN | | 15 | 3 | 80 |
| | | | | | | | | | | | vol % | | |
| | | | | | | | | | | | Sn | | |

In all cases, the use of the BaSO₄/ZnS mixture according to the invention in the particularly preferred composition and content achieves a significant improvement. Examples 21, 23, and 24 show by means of the thermoplastic PEEK and PES, and the duroplastic epoxy-resin that this also applies for other binder types than the PAI used predominantly in the tests.

The following Table 5 reports the test results for sliding bearing layered composite materials comprising a steel back and CuSn10Bi3-bearing metal as substrate and various anti-friction coatings based on a PAI-binder having two different intermediate layers. Three comparative materials are compared, marked with prefix “R,” which contain neither barium sulfate nor zinc sulfide, and in each case a material assigned according to the invention having different filler compositions. Also here, in one case the barium sulfate and the zinc sulfide was added in the form of lithopone (distinguishing mark “L”).

TABLE 5

| | | | | | | | | | Total | | |
|---|---|---|---|---|---|---|---|---|---|---|---|
| | | | | | | | | | Content | | max |
| | | | | | | | | Ratio | BaSO4 + | | UW |
| | | Intermediate | | BaSO4 | | ZnS | | BaSO4/ | ZnS | Solid | load |
| No. | Substrate | Layer | Binder | [vol. %] | | [vol. %] | | ZnS | [vol. %] | lubricant | [MPa] |
| 26 | CuSn10Bi3 | Ni | PAI | 11 | | 4 | | 2.75 | 15 | 20 vol % | 110 |
| | | | | | | | | | | MoS2 | |
| R26 | CuSn10Bi3 | Ni | PAI | | | | | | 0 | 20 vol % | 90 |
| | | | | | | | | | | MoS2 | |
| 27 | CuSn10Bi3 | Ni | PAI | 7.3 | | 2.7 | | 2.65 | 10 | 30 vol % | 95 |
| | | | | | | | | | | MoS2 | |
| R27 | CuSn10Bi3 | Ni | PAI | | | | | | 0 | 40 vol % | 90 |
| | | | | | | | | | | MoS2 | |
| 28 | CuSn10Bi3 | Ag | PAI | 10.2 | L | 4.8 | L | 2.13 | 15 | 30 vol % | 110 |
| | | | | | | | | | | MoS2 | |
| R28 | CuSn10Bi3 | Ag | PAI | | | | | | 0 | 40 vol % | 90 |
| | | | | | | | | | | MoS2 | |

It can be seen that the use of intermediate layers does not impair the effectiveness of the BaSO₄/ZnS mixture. A comparison of example 26 with example 17 In Table 4 shows that also by the change of the substrate of CuNi2Si into CuSn10Bi3 having an Ni-intermediate layer achieves improvement of the load capacity.

The following Table 6 reports the test results for sliding bearing layered composite materials comprising various aluminum-based substrates and various anti-friction coatings based on different matrix materials without intermediate layer. Compared are 6 examples according to the invention with different ratios of barium sulfate to zinc sulfide and different total amounts of these fillers. The other filler contents were also varied. Finally, in one case here the barium sulfate and zinc sulfide were added in the form of lithopone (distinguishing mark “L”).

TABLE 6

| | | | | | | | | Total | | | | | | |
|---|---|---|---|---|---|---|---|---|---|---|---|---|---|---|
| | | | | | | | | Content | | | | | max | |
| | | | | | | | Ratio | BaSO4 + | | | | Amount | UW | |
| | | | BaSO4 | | ZnS | | BaSO4/ | ZnS | Solid | Hard | | Fe₂O₃ | load | |
| No. | Substrate | Binder | [vol. %] | | [vol. %] | | ZnS | [vol. %] | lubricant | material | Metal | [vol. %] | [MPa] | |
| 29 | ALSn10Ni2MnCu | PAI | 3.7 | | 1.3 | | 2.84 | 5 | 20 vol % hBN | | | | 90 | S |
| 30 | ALSn10Ni2MnCu | PES | 10.2 | L | 4.8 | L | 2.13 | 15 | 15 vol % MoS2 | | | 3 | 95 | S |
| 31 | AlNi2MnCu | PAI | 18 | | 7 | | 2.57 | 25 | 15 vol % WS2 | 5 vol % | | | 95 | |
| | | | | | | | | | | SiC | | | | |
| 32 | AlNi2MnCu | EP | 18 | | 7 | | 2.57 | 25 | 15 vol % hBN | | | 5 | 95 | |
| 33 | AlSn6Si4CuMnCr | PAI | 7.3 | | 2.7 | | 2.65 | 10 | 20 vol % MoS2 | 3 vol % | | 5 | 80 | S |
| | | | | | | | | | | B4C | | | | |
| 34 | AlSn6Si4CuMnCr | PEEK | 4 | | 1 | | 4 | 5 | 20 vol % hBN | | 7 vol % | 3 | 85 | S |

Ag

The results demonstrate that also on substrates based on aluminum, the load capacity by addition of BaSO₄/ZnS mixtures to the lubricant coating is further improved. Since the Al alloys are less fatigue-resistant than the Cu alloys, the maximum load in the tests is often not limited by the anti-friction coating, but rather by the fatigue of the substrate itself. In these cases, the results are marked with “S.” However, the fatigue resistibility of the Al-alloys is significantly improved by the lubricant lacquers, and this improvement is also dependent upon the type of lubricant used, which is clearly seen in Table 6.

### LIST OF REFERENCE NUMERALS

10 anti-friction coating composite
11 lower anti-friction coating
12 anti-friction coating
13 upper anti-friction coating
14 substrate
15 surface of the substrate
16 binder, matrix
18 zinc sulfide (ZnS)
20 barium sulfate (BaSO₄)
22 hard material
24 metal particle
26 solid lubricant
28 iron-(III)-oxide
30 anti-friction coating composite
31 lower anti-friction coating
33 upper anti-friction coating
38 bearing shell
40 anti-friction coating composite
41 first anti-friction coating
42 lower anti-friction coating
43 upper anti-friction coating
50 metal coating composite
51 steel support layer
52 intermediate layer
53 bearing metal coating
54 surface of the bearing metal coating

1. An anti-friction coating comprising at least 25 vol. % of a binder and comprising fillers, which include zinc sulfide and barium sulfate, wherein the volume ratio of barium sulfate to zinc sulfide is between 0.1 and 15.7.

2. The anti-friction coating according to claim 1, wherein in total the zinc sulfide and the barium sulfate are contained in the total composition in a proportion of 2 to 35 vol. %.

3. The anti-friction coating according to claim 28, wherein in total the zinc sulfide, the barium sulfate and the additional fillers are contained in the total composition in a proportion of at most 75 vol. %.

4. The anti-friction coating according to claim 1, wherein, the zinc sulfide and the barium sulfate are present in powder form at a d50 value in the range of 0.1 μm to 1.0 μm.

5. The anti-friction coating according to claim 1, wherein the zinc sulfide and barium sulfate fraction is present in the form of lithopone.

6. The anti-friction coating according to claim 1, wherein the binder is selected from the group consisting of PAI, PI, epoxy resins, PBI, silicone resins and highly aromatic thermoplastics.

7. The anti-friction coating according to claim 1, wherein the coating has a thickness of 1 μm to 40 μm.

8. The anti-friction coating according to claim 28, wherein the additional fillers contain at least one solid lubricant.

9. The anti-friction coating according to claim 8, wherein the at least one solid lubricant is selected from the group comprising metal sulfides having layer structure, graphite, hexagonal boron nitride, and PTFE.

10. The anti-friction coating according to claim 28, wherein the additional fillers contain at least one hard material having a total proportion of not more than 10 vol. %.

11. The anti-friction coating according to claim 10, wherein the at least one hard material is selected from the group comprising nitrides, carbides, borides, oxides, in particular SiC, Si3N4, B4C3, cubic boron nitride, TiO2, and SiO2.

12. An anti-friction coating according to claim 28, wherein the additional fillers (28) include at least one metal powder having a total proportion of not more than 30 vol. %.

13. The anti-friction coating according to claim 12, wherein the at least one metal powder is selected from the group comprising the elements Ag, Pb, Au, Sn, Al, Bi, Cu, and alloys of these elements.

14. The anti-friction coating according to claim 28, wherein the additional fillers comprise up to 15 vol. % iron-(III)-oxide.

15. An anti-friction coating composite comprising at least two anti-friction coatings of different compositions according to claim 1.

16. A sliding bearing layered composite material comprising at least one metal layer and an anti-friction coating according to claim 1 applied on a surface of the metal layer.

17. The sliding bearing layered composite material according to claim 16, wherein the surface of the at least one metal layer has a roughness Rz of 1 μm to 10 μm.

18. The sliding bearing layered composite material according to claim 16, wherein the at least one metal layer comprises a bearing metal layer made of an alloy based on one of the elements selected from the group consisting of Cu, Al, Ni, Sn, Zn, Ag, Au, Bi, and Fe.

19. The sliding bearing layered composite material according to claim 16, wherein the at least one metal layer comprises a bearing metal layer made of an alloy selected from the group consisting of CuSn, CuNiSi, CuZn, CuSnZn, AlSn, AlSi, AlSnSi, and AlZn.

20. A sliding bearing layered composite material according to claim 18 wherein the at least one metal layer comprises a steel support layer and optionally an intermediate layer made of Ni, Ag, Cu, or Fe applied on the steel support layer, wherein the bearing metal layer is applied on the steel support layer or, if present, on the intermediate layer, and wherein the anti-friction coating or the anti-friction coating composite is applied on a surface of the bearing metal layer on the side facing away from the steel support layer.

21. An internal combustion engine having a sliding bearing layered composite material according to claim 18 any one of claims 16 to 20 or 27 in a bearing element for an internal combustion engine.

22. The internal combustion engine according to claim 21, wherein the bearing element is a bearing shell of a crankshaft bearing or of a connecting rod bearing, a connecting rod bushing or a thrust washer.

23. The anti-friction coating according to claim 1, wherein the volume ratio of barium sulfate to zinc sulfide is between 0.8 and 4.88.

24. The anti-friction coating according to claim 1, wherein the volume ratio of barium sulfate to zinc sulfide is between 1.5 and 3.44.

25. The anti-friction coating according to claim 2, wherein in total the zinc sulfide and the barium sulfate are contained in the total composition in a proportion of 5 to 25 vol. %.

26. The anti-friction coating according to claim 28, wherein the additional fillers comprise 4 to 10 vol. % of iron-(III)-oxide.

27. The sliding bearing layered composite material according to claim 16, wherein the surface of the at least one metal layer, has a roughness RZ of 3 μm to 8 μm.

28. The anti-friction coating of claim 1, including additional fillers.

29. The anti-friction coating of claim 6, wherein said highly aromatic thermoplastics is selected from the group consisting of polyarylates, PEEK and PES.

30. A sliding bearing layered composite material comprising at least one metal layer and an anti-friction coating composite according to claim 15 applied on a surface of the metal layer.

31. The sliding bearing layered composite according to claim 30, wherein the surface of the at least one metal layer has a roughness R_{z} of 1 μm to 10 μm.

32. The sliding baring layered composite according to claim 30, wherein the at least one metal layer comprises a bearing metal layer made of an alloy based on one of the elements selected from the group consisting of Cu, Al, Ni, Sn, Zn, Ag, Au, Bi, and Fe.

33. The sliding bearing layered composite according to claim 30, wherein the at least one metal layer comprises a bearing metal layer made of an alloy selected form the group consisting of CuSn, CuNiSi, CuZn, CuSnZn, AlSn, AlSi, AlSnSi, and AlZn.

34. The sliding bearing layered composite material according to claim 30, wherein the at least one metal layer comprises a steel support layer and optionally an intermediate layer made of Ni, Ag, Cu, or Fe applied on the steel support layer, wherein the bearing metal layer is applied on the steel support layer or, if present, on the intermediate layer, and wherein the anti-friction coating or the anti-friction coating composite is applied on a surface of the bearing metal layer on the side facing away from the steel support layer.

35. The sliding bearing layered composite material according to claim 30, wherein the surface of the at least one metal layer has a roughness R_{z} of 3 μm to 8 μm.
